(19) United States
(12) Patent Application Publication
(10) Pub. No.: US 2025/0063409 A1
(43) Pub. Date: Feb. 20, 2025

(54) PHASE NOISE REPORTING FOR CONSTELLATION AND WAVEFORM SELECTION

(71) Applicant: QUALCOMM INCORPORATED, San Diego, CA (US)

(72) Inventors: Shay Landis, Hod Hasharon (IL); Idan Michael Horn, Hod Hasharon (IL); Yehonatan Dallal, Kfar Saba (IL)

(21) Appl. No.: 18/720,560

(22) PCT Filed: Jan. 25, 2023
(86) PCT No.: PCT/US2023/061260

§ 371 Date: Jun. 14, 2024

(30) Foreign Application Priority Data
Feb. 18, 2022 (IL) 290723

(51) Int. Cl. H04W 24/10

(52) U.S. Cl. CPC H04W 24/10

(57) ABSTRACT

Methods, systems, and devices for wireless communications are described. A user equipment (UE) may receive, from a network entity, an indication that the UE is to transmit a noise report that includes phase noise information. The UE may determine the phase noise information based on phase noise arising in communications between the UE and the network entity, and may transmit the noise report which includes the phase noise information. Based on receiving the noise report, the network entity may transmit one or more additional communications having at least one parameter that is determined by the network entity based on the noise report.

### CROSS REFERENCES

The present application is a 371 national stage filing of International PCT Application No. PCT/US2023/061260 by LANDIS et al. entitled “PHASE NOISE REPORTING FOR CONSTELLATION AND WAVEFORM SELECTION,” filed Jan. 25, 2023; and claims priority to Israel Patent Application No. 290723 by LANDIS et al. entitled “PHASE NOISE REPORTING FOR CONSTELLATION AND WAVEFORM SELECTION,” filed Feb. 18, 2022, each of which is assigned to the assignee hereof, and each of which is expressly incorporated by reference in its entirety herein.

### FIELD OF TECHNOLOGY

The following relates to wireless communications, including phase noise reporting for constellation and waveform selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities or one or more network access nodes, each simultaneously supporting communication for multiple communication devices, which may be otherwise known as user equipment (UE).

Some wireless communications systems may support communications in relatively higher frequency bands (e.g., FR2, FR4). Communications in these frequencies may be associated with higher levels of some types of noise which may affect communications at a wireless device.

### SUMMARY

The described techniques relate to improved methods, systems, devices, and apparatuses that support phase noise reporting for constellation and waveform selection. Generally, the described techniques provide for mitigating the effects of noise on communications at a wireless device.

In some examples, a wireless device (e.g., such as a user equipment (UE)) may experience one or more types or sources of noise that may impact communications at the UE (e.g., from self-interference cause by communications at the UE, from one or more other wireless devices, phase noise, thermal noise, or otherwise additive noise sources). A second wireless device (e.g., a network entity, such as a base station or aspects thereof) may be able to help mitigate the effects of noise on communications received by the first wireless device by selecting one or more appropriate parameters for transmission from the second wireless device to the first wireless device. However, in order to do this efficiently, the network entity may use information about the noise experienced by the UE to appropriately select the parameters.

To provide the network entity with this information, the UE may transmit a noise report indicating a level of phase noise, a relative level of phase noise (e.g., compared to thermal noise), with one or more other details regarding the phase noise such that a network entity may more effectively select a waveform for downlink communications to improve overall performance at the UE by mitigating potential effects caused by high phase noise levels.

A method is described. The method may include receiving, from a network entity, an indication that the user equipment (UE) is to transmit a noise report that includes phase noise information, determining the phase noise information based on phase noise arising in communications between the UE and the network entity, transmitting the noise report which includes the phase noise information, and receiving, from the network entity, one or more additional communications having at least one parameter that is based on the noise report.

An apparatus is described. The apparatus may include a memory, and a processor coupled with the memory, where the memory includes instructions executable by the processor to cause the apparatus to receive, from a network entity, an indication that the UE is to transmit a noise report that includes phase noise information, determine the phase noise information based on phase noise arising in communications between the UE and the network entity, transmit the noise report which includes the phase noise information, and receive, from the network entity, one or more additional communications having at least one parameter that is based on the noise report.

Another apparatus is described. The apparatus may include means for receiving, from a network entity, an indication that the UE is to transmit a noise report that includes phase noise information, means for determining the phase noise information based on phase noise arising in communications between the UE and the network entity, means for transmitting the noise report which includes the phase noise information, and means for receiving, from the network entity, one or more additional communications having at least one parameter that is based on the noise report.

A non-transitory computer-readable medium storing code is described. The code may include instructions executable by a processor to receive, from a network entity, an indication that the UE is to transmit a noise report that includes phase noise information, determine the phase noise information based on phase noise arising in communications between the UE and the network entity, transmit the noise report which includes the phase noise information, and receive, from the network entity, one or more additional communications having at least one parameter that is based on the noise report.

In some examples of the method, apparatuses, and non-transitory computer-readable medium described herein, transmitting the noise report may include operations, features, means, or instructions for including in the noise report, information for a second type of noise associated with the communications between the UE and the network entity, the second type of noise being different from the phase noise.

In some examples of the method, apparatuses, and non-transitory computer-readable medium described herein, determining the phase noise information may include operations, features, means, or instructions for determining a relative level of the phase noise with respect to the second type of noise.

In some examples of the method, apparatuses, and non-transitory computer-readable medium described herein, determining the phase noise information may include operations, features, means, or instructions for determining a level of the phase noise, the level of the phase noise to be included in the noise report in addition to an additional level of the second type of noise.

In some examples of the method, apparatuses, and non-transitory computer-readable medium described herein, the second type of noise includes thermal noise.

In some examples of the method, apparatuses, and non-transitory computer-readable medium described herein, determining the phase noise information may include operations, features, means, or instructions for determining a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

In some examples of the method, apparatuses, and non-transitory computer-readable medium described herein, receiving the indication may include operations, features, means, or instructions for receiving control signaling including the indication to transmit the noise report.

In some examples of the method, apparatuses, and non-transitory computer-readable medium described herein, the control signaling includes a channel state information reference signal.

Some examples of the method, apparatuses, and non-transitory computer-readable medium described herein may further include operations, features, means, or instructions for receiving an additional indication that at least one parameter may have changed for one or more additional communications received from the network entity, where the at least one parameter may be changed based on the noise report, and where the at least one parameter may be from a set of multiple parameters that pertain to a square quadrature amplitude modulation (QAM), a non-square QAM, differential modulation, non-differential modulation, a single carrier waveform, a multi-carrier waveform, or combinations thereof.

A method for wireless communication at a network entity is described. The method may include transmitting an indication for the UE to transmit a noise report that includes phase noise information, receiving the noise report including the phase noise information which is based on phase noise arising in communications between the UE and the network entity, and transmitting one or more additional communications having at least one parameter that is determined by the network entity based on the noise report.

An apparatus for wireless communication at a network entity is described. An apparatus is described. The apparatus may include a memory, and a processor coupled with the memory, where the memory includes instructions executable by the processor to cause the apparatus to transmit an indication for the UE to transmit a noise report that includes phase noise information, receive the noise report including the phase noise information which is based on phase noise arising in communications between the UE and the network entity, and transmit one or more additional communications having at least one parameter that is determined by the network entity based on the noise report.

Another apparatus for wireless communication at a network entity is described. The apparatus may include means for transmitting an indication for the UE to transmit a noise report that includes phase noise information, means for receiving the noise report including the phase noise information which is based on phase noise arising in communications between the UE and the network entity, and means for transmitting, one or more additional communications having at least one parameter that is determined by the network entity based on the noise report.

A non-transitory computer-readable medium storing code for wireless communication at a network entity is described. The code may include instructions executable by a processor to transmit an indication for the UE to transmit a noise report that includes phase noise information, receive the noise report including the phase noise information which is based on phase noise arising in communications between the UE and the network entity, and transmit one or more additional communications having at least one parameter that is determined by the network entity based on the noise report.

In some examples of the method, apparatuses, and non-transitory computer-readable medium described herein, receiving the noise report may include operations, features, means, or instructions for receiving, in the noise report, information for a second type of noise associated with the communications between the UE and the network entity, the second type of noise being different from the phase noise.

In some examples of the method, apparatuses, and non-transitory computer-readable medium described herein, receiving the noise report may include operations, features, means, or instructions for receiving, in the noise report, a relative level of the phase noise with respect to the second type of noise.

In some examples of the method, apparatuses, and non-transitory computer-readable medium described herein, receiving the noise report may include operations, features, means, or instructions for receiving, in the noise report, a level of the phase noise in addition to an additional level of the second type of noise.

In some examples of the method, apparatuses, and non-transitory computer-readable medium described herein, the second type of noise includes thermal noise.

In some examples of the method, apparatuses, and non-transitory computer-readable medium described herein, receiving the noise report may include operations, features, means, or instructions for receiving, in the noise report, a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

Some examples of the method, apparatuses, and non-transitory computer-readable medium described herein may further include operations, features, means, or instructions for selecting the at least one parameter from a set of multiple parameters based on the phase noise information included in the noise report.

In some examples of the method, apparatuses, and non-transitory computer-readable medium described herein, the set of multiple parameters includes one or more of a square QAM, a non-square QAM, differential modulation, non-differential modulation, a single carrier waveform, or a multi-carrier waveform.

In some examples of the method, apparatuses, and non-transitory computer-readable medium described herein, transmitting the indication may include operations, features, means, or instructions for transmitting control signaling including the indication for the UE to transmit the noise report.

In some examples of the method, apparatuses, and non-transitory computer-readable medium described herein, the control signaling includes a channel state information reference signal.

### BRIEF DESCRIPTION OF THE DRAWINGS

FIG. 1 illustrates an example of a wireless communications system that supports phase noise reporting for constellation and waveform selection in accordance with aspects of the present disclosure.

FIG. 2 illustrates an example of a wireless communication system that supports phase noise reporting for constellation and waveform selection in accordance with aspects of the present disclosure.

FIG. 3 illustrates an example of a process flow that supports phase noise reporting for constellation and waveform selection in accordance with aspects of the present disclosure.

FIGS. 4 and 5 show block diagrams of devices that support phase noise reporting for constellation and waveform selection in accordance with aspects of the present disclosure.

FIG. 6 shows a block diagram of a communications manager that supports phase noise reporting for constellation and waveform selection in accordance with aspects of the present disclosure.

FIG. 7 shows a diagram of a system including a device that supports phase noise reporting for constellation and waveform selection in accordance with aspects of the present disclosure.

FIGS. 8 and 9 show block diagrams of devices that support phase noise reporting for constellation and waveform selection in accordance with aspects of the present disclosure.

FIG. 10 shows a block diagram of a communications manager that supports phase noise reporting for constellation and waveform selection in accordance with aspects of the present disclosure.

FIG. 11 shows a diagram of a system including a device that supports phase noise reporting for constellation and waveform selection in accordance with aspects of the present disclosure.

FIGS. 12 through 15 show flowcharts illustrating methods that support phase noise reporting for constellation and waveform selection in accordance with aspects of the present disclosure.

### DETAILED DESCRIPTION

Some wireless communications systems may support communications in relatively higher frequency bands (e.g., FR2, FR4). Communications in these frequencies may be associated with higher levels of some types of noise, for example, such as phase noise. In some examples, an overall noise level associated with communications between a network entity and a user equipment (UE) may be used to determine the constellation or modulation and coding scheme for minimizing the effects of noise, but when the phase noise level is high (e.g., when communicating in higher frequency bands), a different communication configuration may be more appropriate given a same overall level of the noise. That is, some communications configurations may be more effective in the presence of high phase noise than others even when an overall noise level is the same.

A UE may transmit a noise report indicating a level of phase noise, a relative level of phase noise (e.g., compared to thermal noise), or one or more other details regarding the phase noise such that a network entity may more effectively select a waveform for downlink communications to improve overall performance at the UE by mitigating potential effects caused by high phase noise levels. The UE may be configured by the network entity to transmit the report based on a trigger or may transmit the report periodically. Based on the report, the network entity may select the most appropriate waveform for downlink communications. For example, the network entity may select one or more of the following options based on the report: square quadrature amplitude modulation (QAM) vs. non-square QAM, differential vs. non-differential modulation, or single carrier vs. multi-carrier waveforms. That is, the network entity may select the communication option that is most effective for the noise types or levels indicated in the report.

Aspects of the disclosure are initially described in the context of wireless communications systems. Aspects of the disclosure are further described in the context of a process flow. Aspects of the disclosure are further illustrated by and described with reference to apparatus diagrams, system diagrams, and flowcharts that relate to phase noise reporting for constellation and waveform selection.

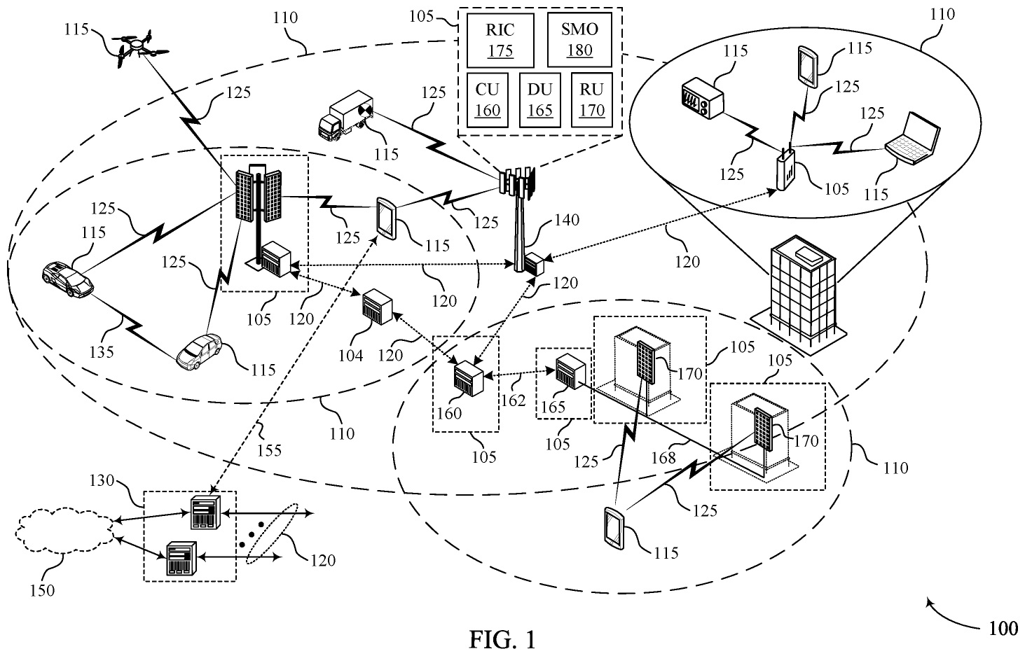

FIG. 1 illustrates an example of a wireless communications system 100 that supports phase noise reporting for constellation and waveform selection in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support phase noise reporting for constellation and waveform selection as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of TS=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples of the wireless communications system 100, a wireless device, such as a UE 115 may experience one or more types or sources of noise that may impact communications at the UE 115 (e.g., from communications performed by the UE 115, from one or more other wireless devices such as another UE 115, a network entity 105, from one or more other sources, phase noise, thermal noise, or otherwise additive noise sources). A second wireless device, such as a network entity 105 may be able to help mitigate the effects of noise on communications received by the UE 115 by selecting one or more parameters for transmission from the network entity 105 to the UE 115.

The UE 115 may transmit a noise report indicating a level of phase noise, a relative level of phase noise (e.g., compared to thermal noise), or one or more other details regarding the phase noise such that a network entity may more effectively select a waveform for downlink communications to improve overall performance at the UE by mitigating potential effects caused by high phase noise levels.

For example, the UE 115 may receive, from the network entity 105, an indication that the UE 115 is to transmit a noise report that includes phase noise information. The UE 115 may determine phase noise information based on phase noise arising in communications between the UE and the network entity, and may transmit the noise report which includes the phase noise information. In some examples, based on receiving the noise report, the network entity 105 may select at least one parameter from a plurality of parameters for subsequent communications with the UE 115 and may transmit, e.g., to the UE 115, one or more additional communications having at least one parameter that is determined by the network entity 105 based on the phase noise information in the noise report.

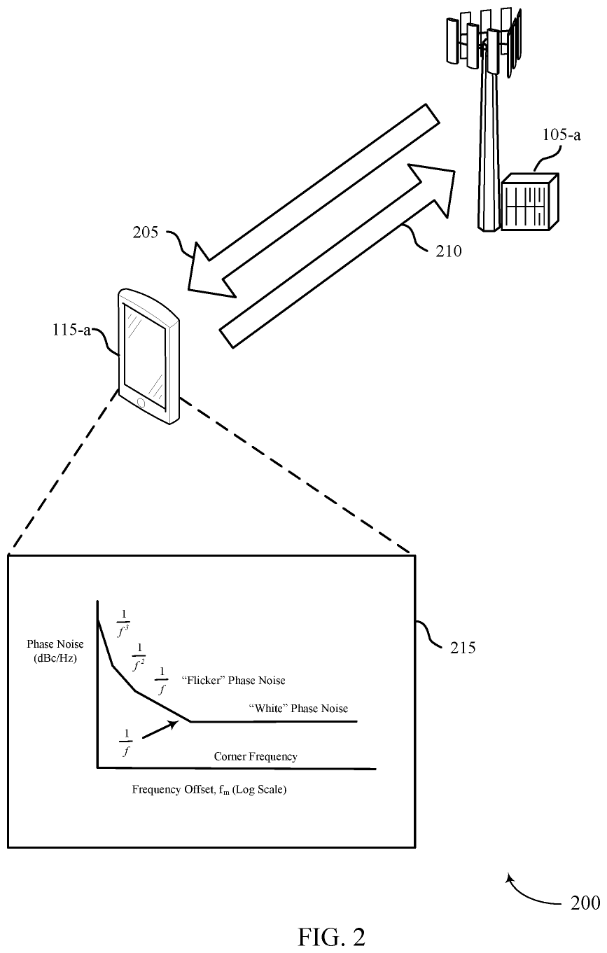

FIG. 2 illustrates an example of a wireless communications system 200 that supports phase noise reporting for constellation and waveform selection in accordance with aspects of the present disclosure. In some examples, wireless communications system 200 may implement aspects of wireless communications system 100. Wireless communications system 200 may include a network entity 105-a and a UE 115-a which may be examples of the corresponding devices as described with reference to FIG. 1.

The wireless communications system 200 may support communications in relatively higher frequency bands (e.g., FR2, FR2x, FR4), which may utilize single-carrier waveforms for downlink communications (e.g., a DFT-S-OFDM waveform). In some examples, noise (e.g., phase noise) at these operating frequencies may be associated with higher levels than at other operating frequencies. In some examples, an overall noise level (e.g., including phase noise and other types of noise) may be used to determine a constellation or modulation coding scheme for communications between the UE 115-a and the network entity 105-a, but in some cases (e.g., high phase noise situations) one constellation may be more efficient for communications than other constellations even when an overall noise level is the same. For example, a non-square constellation may perform better than other constellations (e.g., square QAM) in the presence of strong phase noise.

In some examples, the UE 115-a may provide information (e.g., relative strengths, relative magnitudes, relative levels, or absolute levels, strengths, or magnitudes), via uplink 210, that is related to phase noise experienced at the UE 115-a while communicating (e.g., using higher frequency bands) with the network entity 105-a (or, for example, one or more other wireless devices) which may help the network entity 105-a increase the efficiency of a downlink waveform transmitted via downlink 205. For example, such information may assist the network entity 105-a in making an informed decision or selection of a constellation parameter (e.g., type), amplitude modulation parameter, pulse modulation parameter, waveform parameter, or any combination thereof.

For example, the UE 115-a may transmit a noise report (which, in some examples, may be referred to as a phase noise report) to the network entity 105-a via uplink 210. In some examples, the report may include noise levels, strengths, or noise types, among other examples. Additionally or alternatively, the report may include a type of phase noise (e.g., Gaussian or Weiner).

Based on receiving the report, network entity 105-a may enhance a downlink waveform (e.g., in higher frequency bands) and may thereby increase performance at the UE 115-a. For example, the network entity 105-a may select one or more parameters for a downlink communication (e.g., waveform) such that the waveform may be efficiently received by the UE 115-a even in the presence of high noise or high phase noise. In some examples, the selection may be further based on a relative ratio of noise types of an overall noise level as indicated in the noise report.

The UE 115-a may transmit a noise report to the network entity 105-a including phase noise information and in some cases, additionally including noise information related to other additive noise sources (e.g., thermal noise). For example, the noise report may include a phase noise level, a thermal noise level, a relative (e.g., to one or more other sources of additive noise) phase noise level, a phase noise type (e.g., Gaussian noise, Weiner noise, or flicker noise), cutoff frequencies for portions of a phase noise function (e.g., cutoff frequencies for

$$\frac{1}{{f}^{3}} , \frac{1}{{f}^{2}} , \frac{1}{f} ,$$

f of a phase noise curve) as described with reference to noise diagram 215.

Noise diagram 215 may show a relationship between phase noise in decibels per hertz (e.g., dBc/Hz) and a log scale frequency offset (e.g., fₘ). The noise diagram 215 may illustrate various functions of the relationship between phase noise and frequency offset. For example, a first set of frequency offsets may be associated with a phase noise of

$$\frac{1}{{f}^{3}} ,$$

a second set of frequency offsets may be associated with a phase noise of

$$\frac{1}{{f}^{2}} ,$$

a third set of frequency offsets may be associated with a phase noise of

$$\frac{1}{f} ,$$

and a fourth set of frequency offsets may be associated with a phase noise of f, among other examples. In some examples, the phase noise experienced by the UE 115-a operating in the third set of frequency offsets associated with a phase noise of 1/f may be referred to as flicker noise. In some examples, the frequency at which the phase noise function transitions from

$$\frac{1}{f}$$

to f, may be referred to as a corner frequency. In some examples, the phase noise experienced by the UE 115-a operating in the fourth set of frequency offsets associated with the phase noise, f may be referred to as “white” phase noise. Each phase noise function

$$( e . g . , \frac{1}{{f}^{3}} , \frac{1}{{f}^{2}} , \frac{1}{f} , f )$$

may be associated with a phase noise cutoff frequency (e.g., the frequency at which the relationship between phase noise and frequency offset changes from one function to another). The noise diagram 215 may be an example of information provided to the network entity 105-a in the noise report or may be an exemplary means for a UE to determine phase noise information to be included in the noise report.

For example, the UE 115-a may transmit the noise report autonomously, or periodically, or sporadically, or based on a trigger (e.g., such as satisfying a noise threshold), or based on an indication from the network entity 105-a, among other examples. For example, the network entity 105-a may transmit signaling to the UE 115-a, indicating that the UE 115-a is to transmit a noise report. In some examples, the indication may further indicate whether the UE 115-a is to transmit the noise report periodically or singularly corresponding to report request indications. In some examples, the signaling may be control signaling, and in some cases, may be channel state information (CSI)-reference signal (RS) signaling. The network entity 105-a may receive the noise report via uplink 210 and may select a suitable (e.g., most effective, or efficient) waveform based one selecting one or more parameters for downlink communications with the UE 115-a and may transmit one or more additional communications to the UE 115-a via the downlink 205 using the one or more selected parameters.

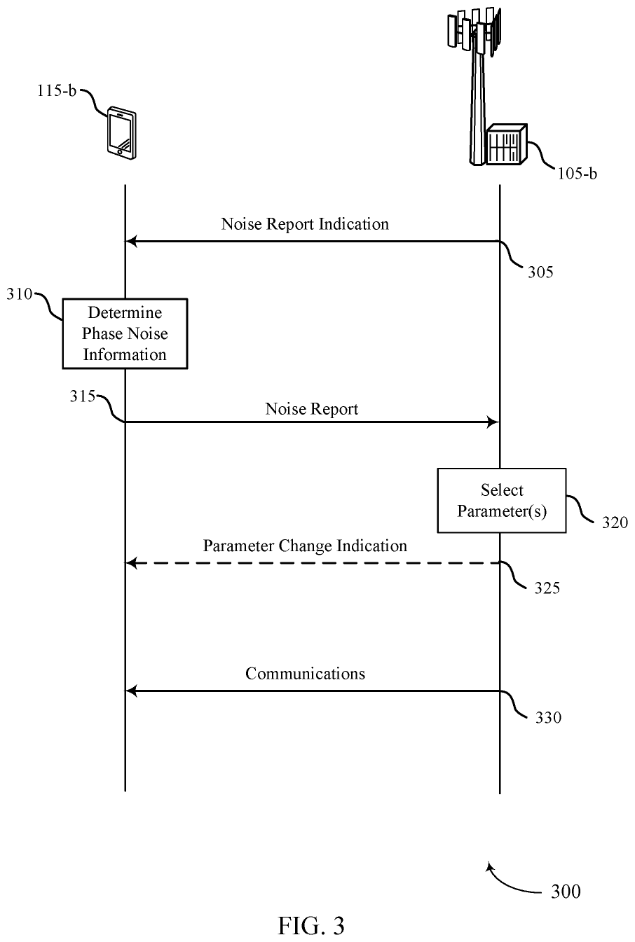

FIG. 3 illustrates an example of a process flow 300 that supports phase noise reporting for constellation and waveform selection in accordance with aspects of the present disclosure. The process flow 300 may implement or be implemented by aspects of wireless communications system 100 or 200. For example, the process flow 300 may illustrate operations between a UE 115-b and a network entity 105-b, which may be examples of a UE 115 and a network entity 105, as described with reference to FIG. 1. In the following description of the process flow 300, the operations between the UE 115-b and the network entity 105-b may be transmitted in a different order than the example order shown, or the operations performed by the UE 115-b and the network entity 105-b may be performed in different orders or at different times or by different devices. Some operations may also be omitted from the process flow 300, and other operations may be added to the process flow 300.

At 305, the network entity 105-b may transmit signaling to the UE 115-b that indicates that the UE 115-b is to transmit a noise report, for example, to the network entity 105-b. In some examples, the signaling may be control signaling and, in some examples, may be CSI-RS signaling. In some examples, the signaling may indicate that the UE 115-b is to transmit a noise report to one or more other devices.

At 310, the UE 115-b may determine phase noise information. For example, the UE 115-b may determine a level (e.g., relative magnitude, absolute magnitude, amount) of the phase noise. In some examples, the UE 115-b may determine the level of phase noise based on an amount of phase noise in units of dBc/Hz. In some examples, the UE 115-a may additionally determine information related to one or more other types of noise and the UE may determine a relative level of the phase noise with respect to the second type of noise, or a level of the second type of noise, or both, for inclusion in the phase noise report. In some examples, the second type of noise may be thermal noise.

Additionally or alternatively, the UE 115-b may determine a phase noise level associated with a frequency of communications between the UE 115-b and the network entity 105-b, a cutoff frequency associated with a set of frequencies for the communications between the UE 115-b and the network entity 105-b (e.g., a

$$\frac{1}{{f}^{3}}$$

cutoff, a

$$\frac{1}{{f}^{2}}$$

cutoff, a

$$\frac{1}{f}$$

cutoff, and a cutoff or starting frequency offset for white phase noise (e.g., flat phase noise areas), a rate of change of the phase noise as a function of frequency for the communications between the UE 115-b and the network entity 105-b (e.g.,

$$\frac{1}{{f}^{3}} ; \frac{1}{{f}^{2}} ; \frac{1}{f} ;$$

flat phase noise areas), a type of rate of change of the phase noise as a function of frequency for the communications between the UE 115-b and the network entity 105-b (e.g., Gaussian, Weiner), or some combination thereof, for inclusion in the noise report.

At 315, the UE 115-b may transmit a noise report including the determine information about the phase noise, and additionally in some examples, the second type of noise that is different from the phase noise.

At 320, the network entity 105-b may determine or select at least one parameter from a plurality of parameters for transmitting subsequent communications to the UE 115-b based on the information included in the noise report. For example, the network entity 105-b may select an amplitude modulation type (e.g., square QAM, or non-square QAM), a modulation type (e.g., a pulse modulation type, a differential modulation, a differential pulse modulation, a non-differential modulation, or a non-differential pulse modulation) or a type of waveform (e.g., DFT-S-OFDM, or OFDM (which may be an example of a multi-carrier waveform)), among other examples.

Optionally, at 325, the network entity may transmit a second indication that at least one parameter for communications between the UE 115-b and the network entity 105-b has changed. For example, UE 115-b may receive the second indication and determine that a parameter associated with communications (e.g., previous communications) with the network entity 105-b has changed (e.g., by the network entity 105-b) for one or more additional communications (e.g., subsequent communications) with the network entity 105-b.

At 330, the network entity 105-b may transmit, e.g., to the UE 115-b, one or more additional communications (e.g., subsequent communications) having the at least one changed parameter as determined (e.g., selected) by the network entity according to the noise information included in the noise report.

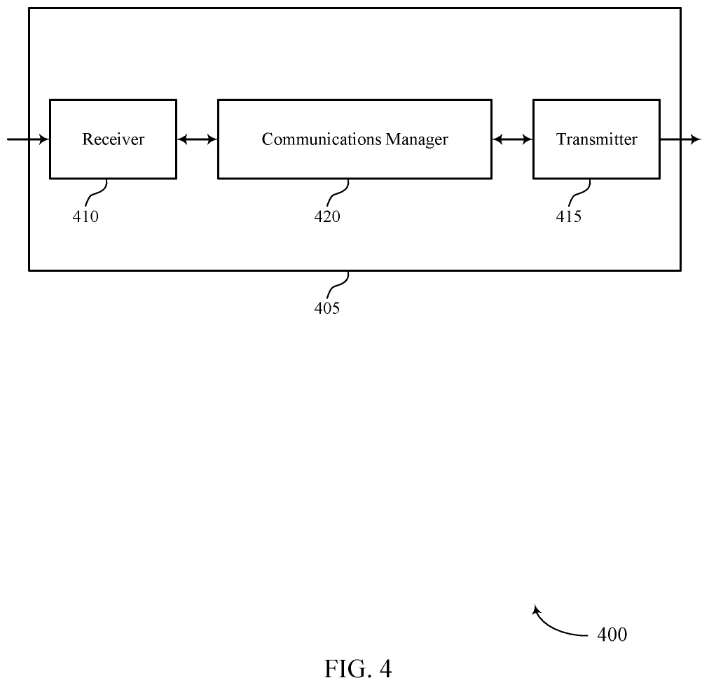

FIG. 4 shows a block diagram 400 of a device 405 that supports phase noise reporting for constellation and waveform selection in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to phase noise reporting for constellation and waveform selection). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to phase noise reporting for constellation and waveform selection). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of phase noise reporting for constellation and waveform selection as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

For example, the communications manager 420 may be configured as or otherwise support a means for receiving, from a network entity, an indication that the UE is to transmit a noise report that includes phase noise information. The communications manager 420 may be configured as or otherwise support a means for determining the phase noise information based on phase noise arising in communications between the UE and the network entity. The communications manager 420 may be configured as or otherwise support a means for transmitting the noise report which includes the phase noise information. The communications manager 420 may be configured as or otherwise support a means for receiving, from the network entity, one or more additional communications having at least one parameter that is based on the noise report.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced processing, reduced power consumption, and more efficient utilization of communication resources, among other examples.

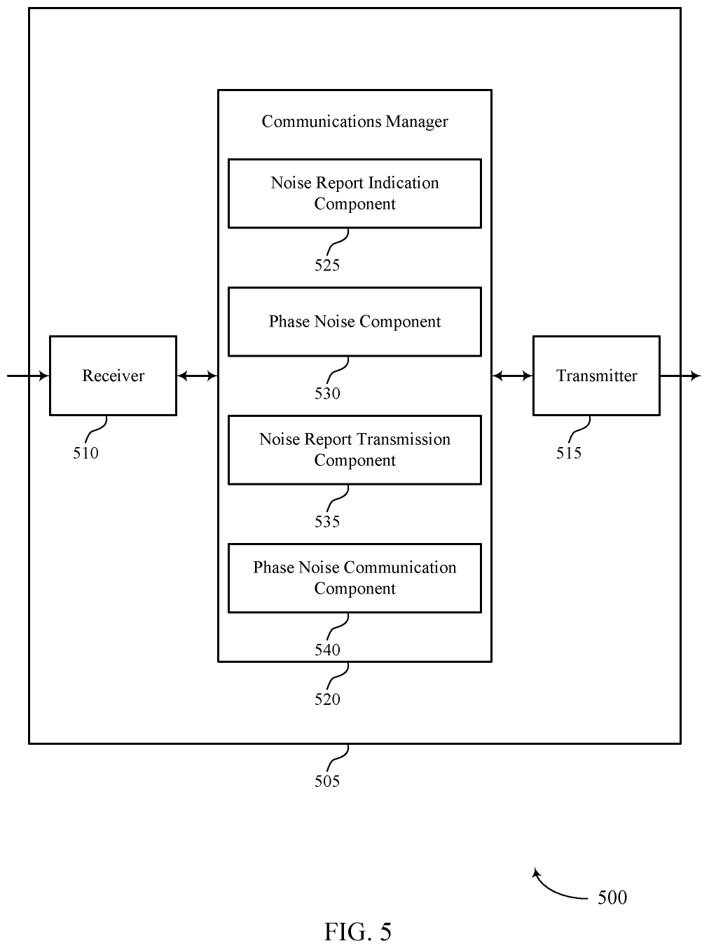

FIG. 5 shows a block diagram 500 of a device 505 that supports phase noise reporting for constellation and waveform selection in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to phase noise reporting for constellation and waveform selection). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to phase noise reporting for constellation and waveform selection). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of phase noise reporting for constellation and waveform selection as described herein. For example, the communications manager 520 may include a noise report indication component 525, a phase noise component 530, a noise report transmission component 535, a phase noise communication component 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The noise report indication component 525 may be configured as or otherwise support a means for receiving, from a network entity, an indication that the UE is to transmit a noise report that includes phase noise information. The phase noise component 530 may be configured as or otherwise support a means for determining the phase noise information based on phase noise arising in communications between the UE and the network entity. The noise report transmission component 535 may be configured as or otherwise support a means for transmitting the noise report which includes the phase noise information. The phase noise communication component 540 may be configured as or otherwise support a means for receiving, from the network entity, one or more additional communications having at least one parameter that is based on the noise report.

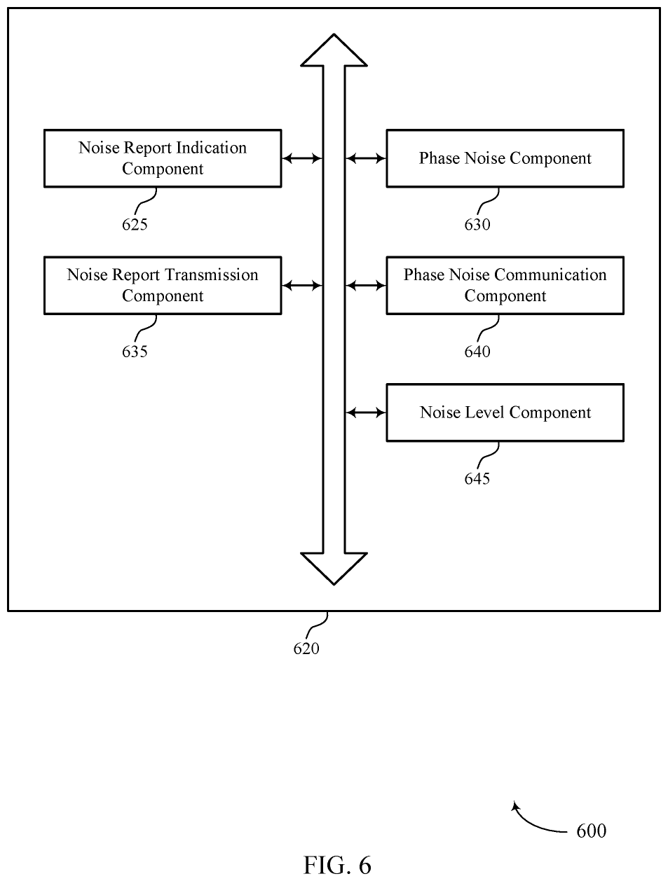

FIG. 6 shows a block diagram 600 of a communications manager 620 that supports phase noise reporting for constellation and waveform selection in accordance with aspects of the present disclosure. The communications manager 620 may be an example of aspects of a communications manager 420, a communications manager 520, or both, as described herein. The communications manager 620, or various components thereof, may be an example of means for performing various aspects of phase noise reporting for constellation and waveform selection as described herein. For example, the communications manager 620 may include a noise report indication component 625, a phase noise component 630, a noise report transmission component 635, a phase noise communication component 640, a noise level component 645, or any combination thereof. Each of these components may communicate, directly or indirectly, with one another (e.g., via one or more buses).

The noise report indication component 625 may be configured as or otherwise support a means for receiving, from a network entity, an indication that the UE is to transmit a noise report that includes phase noise information. The phase noise component 630 may be configured as or otherwise support a means for determining the phase noise information based on phase noise arising in communications between the UE and the network entity. The noise report transmission component 635 may be configured as or otherwise support a means for transmitting the noise report which includes the phase noise information. The phase noise communication component 640 may be configured as or otherwise support a means for receiving, from the network entity, one or more additional communications having at least one parameter that is based on the noise report.

In some examples, to support transmitting the noise report, the phase noise component 630 may be configured as or otherwise support a means for including in the noise report information for a second type of noise associated with the communications between the UE and the network entity, the second type of noise being different from the phase noise.

In some examples, to support determining the phase noise information, the noise level component 645 may be configured as or otherwise support a means for determining a relative level of the phase noise with respect to the second type of noise.

In some examples, to support determining the phase noise information, the noise level component 645 may be configured as or otherwise support a means for determining a level of the phase noise, the level of the phase noise to be included in the noise report in addition to an additional level of the second type of noise.

In some examples, the second type of noise includes thermal noise.

In some examples, to support determining the phase noise information, the noise level component 645 may be configured as or otherwise support a means for determining a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

In some examples, to support receiving the indication, the noise report indication component 625 may be configured as or otherwise support a means for receiving control signaling including the indication to transmit the noise report.

In some examples, the control signaling includes a channel state information reference signal.

In some examples, the phase noise communication component 640 may be configured as or otherwise support a means for receiving an additional indication that at least one parameter has changed for one or more additional communications received from the network entity, where the at least one parameter is changed based on the noise report, and where the at least one parameter is from a set of multiple parameters that pertain to a square QAM, a non-square QAM, differential modulation, non-differential modulation, a single carrier waveform, a multi-carrier waveform, or combinations thereof.

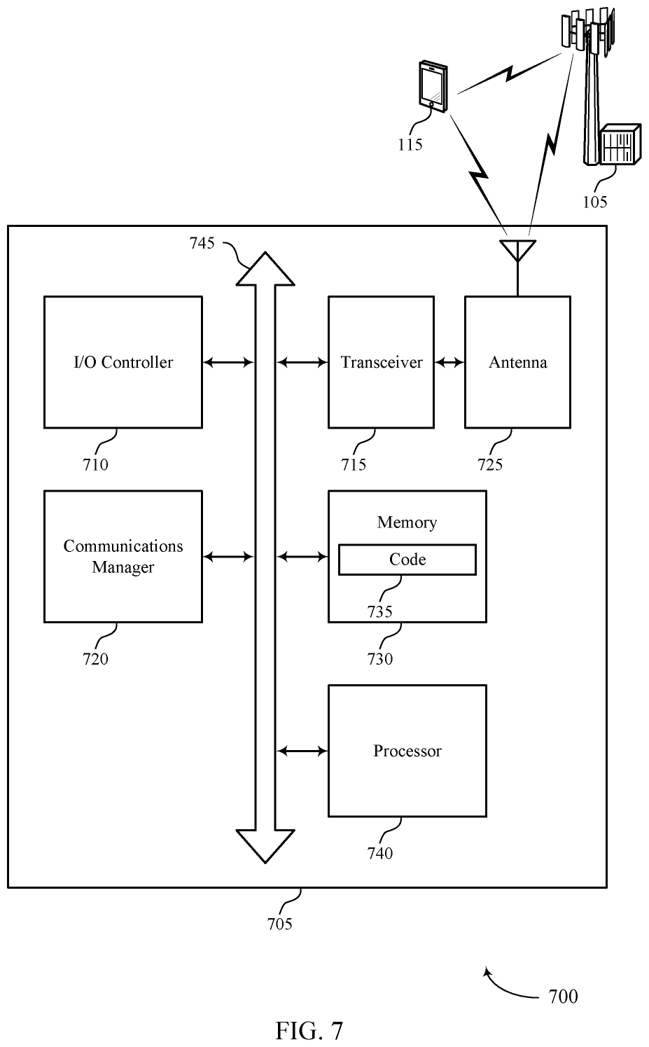

FIG. 7 shows a diagram of a system 700 including a device 705 that supports phase noise reporting for constellation and waveform selection in accordance with aspects of the present disclosure. The device 705 may be an example of or include the components of a device 405, a device 505, or a UE 115 as described herein. The device 705 may communicate wirelessly with one or more network entitys 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting phase noise reporting for constellation and waveform selection). For example, the device 705 or a component of the device 705 may include a processor 740 and memory 730 coupled with or to the processor 740, the processor 740 and memory 730 configured to perform various functions described herein.

For example, the communications manager 720 may be configured as or otherwise support a means for receiving, from a network entity, an indication that the UE is to transmit a noise report that includes phase noise information. The communications manager 720 may be configured as or otherwise support a means for determining the phase noise information based on phase noise arising in communications between the UE and the network entity. The communications manager 720 may be configured as or otherwise support a means for transmitting the noise report which includes the phase noise information. The communications manager 720 may be configured as or otherwise support a means for receiving, from the network entity, one or more additional communications having at least one parameter that is based on the noise report.

By including or configuring the communications manager 720 in accordance with examples as described herein, the device 705 may support techniques for improved communication reliability, reduced latency, more efficient utilization of communication resources, improved coordination between devices, among other examples.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of phase noise reporting for constellation and waveform selection as described herein, or the processor 740 and the memory 730 may be otherwise configured to perform or support such operations.

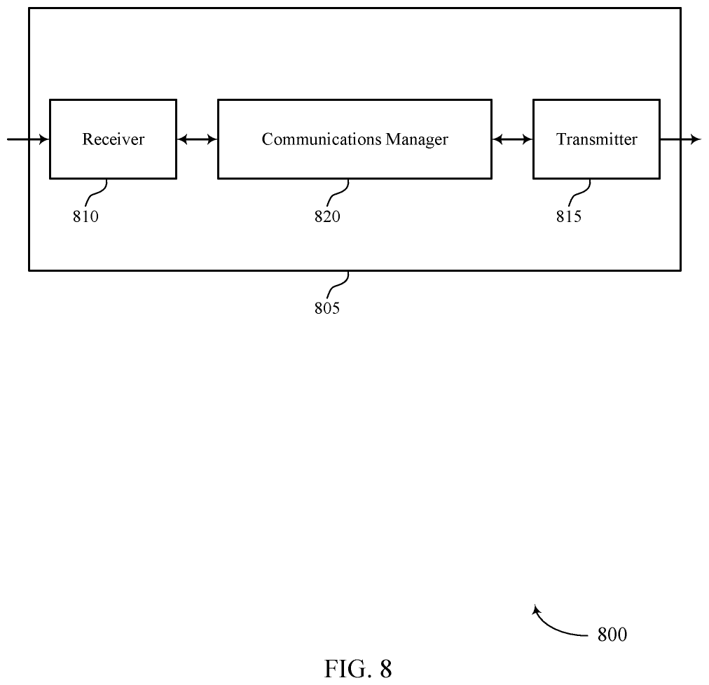

FIG. 8 shows a block diagram 800 of a device 805 that supports phase noise reporting for constellation and waveform selection in accordance with aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to phase noise reporting for constellation and waveform selection). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to phase noise reporting for constellation and waveform selection). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of phase noise reporting for constellation and waveform selection as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a network entity in accordance with examples as disclosed herein. For example, the communications manager 820 may be configured as or otherwise support a means for transmitting an indication for the UE to transmit a noise report that includes phase noise information. The communications manager 820 may be configured as or otherwise support a means for receiving the noise report including the phase noise information which is based at least in part on phase noise arising in communications between the UE and the network entity. The communications manager 820 may be configured as or otherwise support a means for transmitting one or more additional communications having at least one parameter that is determined by the network entity based on the noise report.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, and more efficient utilization of communication resources, among other examples.

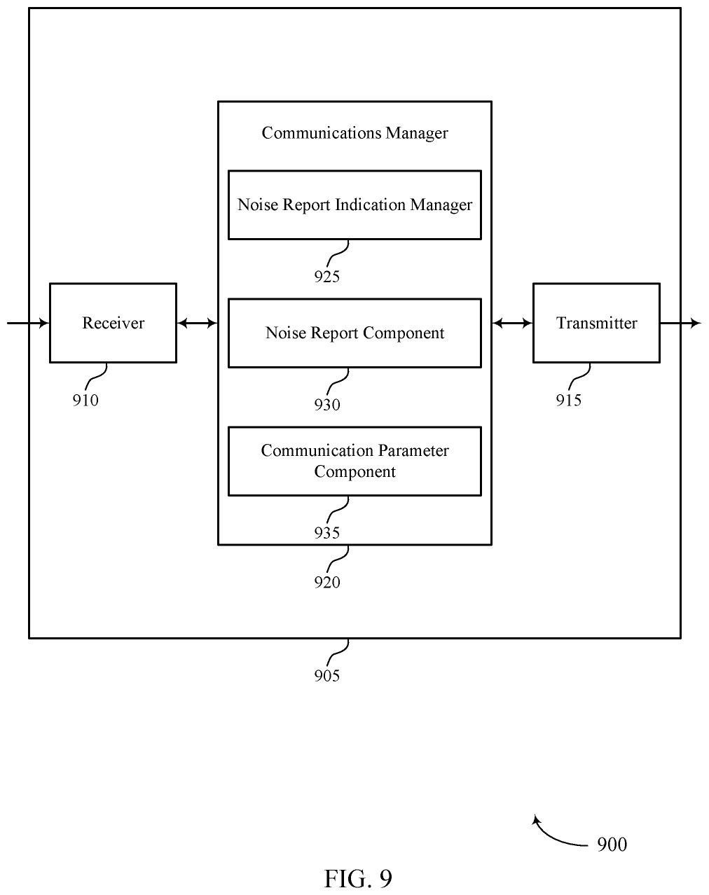

FIG. 9 shows a block diagram 900 of a device 905 that supports phase noise reporting for constellation and waveform selection in accordance with aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to phase noise reporting for constellation and waveform selection). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to phase noise reporting for constellation and waveform selection). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of phase noise reporting for constellation and waveform selection as described herein. For example, the communications manager 920 may include a noise report indication manager 925, a noise report component 930, a communication parameter component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network entity in accordance with examples as disclosed herein. The noise report indication manager 925 may be configured as or otherwise support a means for transmitting an indication for the UE to transmit a noise report that includes phase noise information. The noise report component 930 may be configured as or otherwise support a means for receiving the noise report including the phase noise information which is based at least in part on phase noise arising in communications between the UE and the network entity. The communication parameter component 935 may be configured as or otherwise support a means for transmitting one or more additional communications having at least one parameter that is determined by the network entity based on the noise report.

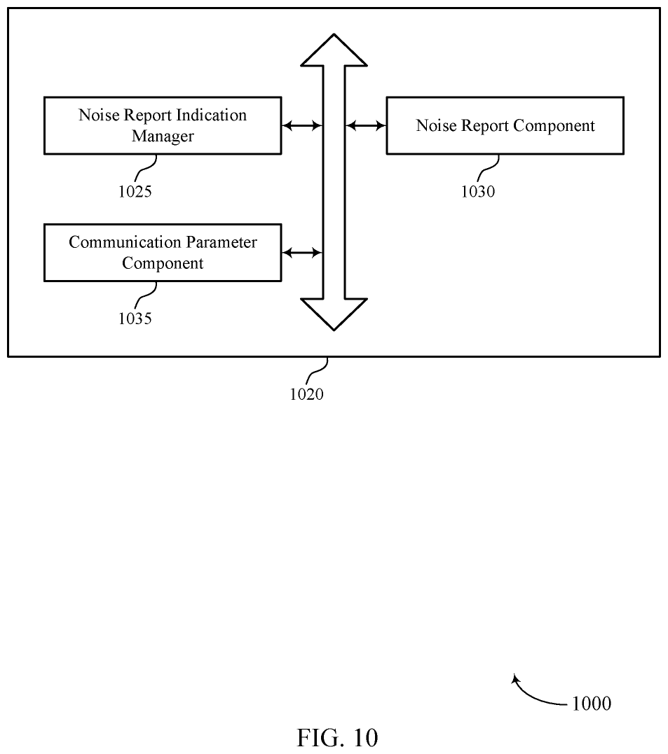

FIG. 10 shows a block diagram 1000 of a communications manager 1020 that supports phase noise reporting for constellation and waveform selection in accordance with aspects of the present disclosure. The communications manager 1020 may be an example of aspects of a communications manager 820, a communications manager 920, or both, as described herein. The communications manager 1020, or various components thereof, may be an example of means for performing various aspects of phase noise reporting for constellation and waveform selection as described herein. For example, the communications manager 1020 may include a noise report indication manager 1025, a noise report component 1030, a communication parameter component 1035, or any combination thereof. Each of these components may communicate, directly or indirectly, with one another (e.g., via one or more buses).

The communications manager 1020 may support wireless communication at a network entity in accordance with examples as disclosed herein. The noise report indication manager 1025 may be configured as or otherwise support a means for transmitting an indication for the UE to transmit a noise report that includes phase noise information. The noise report component 1030 may be configured as or otherwise support a means for receiving the noise report including the phase noise information which is based at least in part on phase noise arising in communications between the UE and the network entity. The communication parameter component 1035 may be configured as or otherwise support a means for transmitting one or more additional communications having at least one parameter that is determined by the network entity based on the noise report.

In some examples, to support receiving the noise report, the noise report component 1030 may be configured as or otherwise support a means for receiving, in the noise report, information for a second type of noise associated with the communications between the UE and the network entity, the second type of noise being different from the phase noise.

In some examples, to support receiving the noise report, the noise report component 1030 may be configured as or otherwise support a means for receiving, in the noise report, a relative level of the phase noise with respect to the second type of noise.

In some examples, to support receiving the noise report, the noise report component 1030 may be configured as or otherwise support a means for receiving, in the noise report, a level of the phase noise in addition to an additional level of the second type of noise.

In some examples, the second type of noise includes thermal noise.

In some examples, to support receiving the noise report, the noise report component 1030 may be configured as or otherwise support a means for receiving, in the noise report, a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

In some examples, the communication parameter component 1035 may be configured as or otherwise support a means for selecting the at least one parameter from a set of multiple parameters based on the phase noise information included in the noise report.

In some examples, the set of multiple parameters includes one or more of a square QAM, a non-square QAM, differential modulation, non-differential modulation, a single carrier waveform, or a multi-carrier waveform.

In some examples, to support transmitting the indication, the noise report indication manager 1025 may be configured as or otherwise support a means for transmitting control signaling including the indication for the UE to transmit the noise report.

In some examples, the control signaling includes a channel state information reference signal.

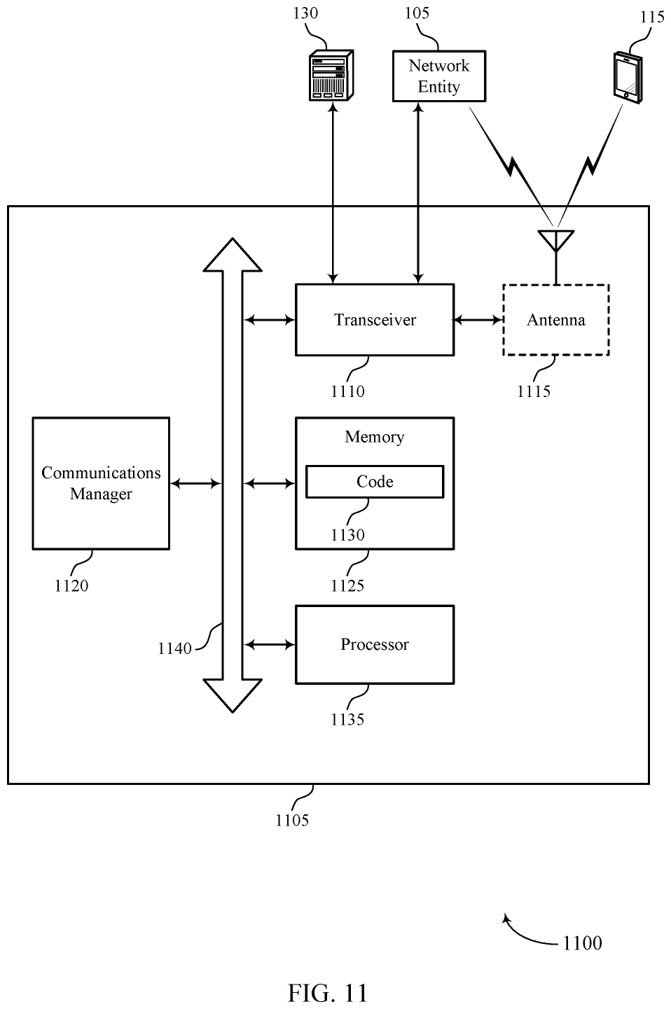

FIG. 11 shows a diagram of a system 1100 including a device 1105 that supports phase noise reporting for constellation and waveform selection in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting phase noise reporting for constellation and waveform selection). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for transmitting an indication for a UE to transmit a noise report that includes phase noise information. The communications manager 1120 may be configured as or otherwise support a means for receiving the noise report including the phase noise information which is based on phase noise arising in communications between the UE and the network entity. The communications manager 1120 may be configured as or otherwise support a means for transmitting one or more additional communications having at least one parameter that is determined by the network entity based on the noise report.

By including or configuring the communications manager 1120 in accordance with examples as described herein, the device 1105 may support techniques for improved communication reliability, reduced latency, more efficient utilization of communication resources, improved coordination between devices, among other examples.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of phase noise reporting for constellation and waveform selection as described herein, or the processor 1135 and the memory 1125 may be otherwise configured to perform or support such operations.

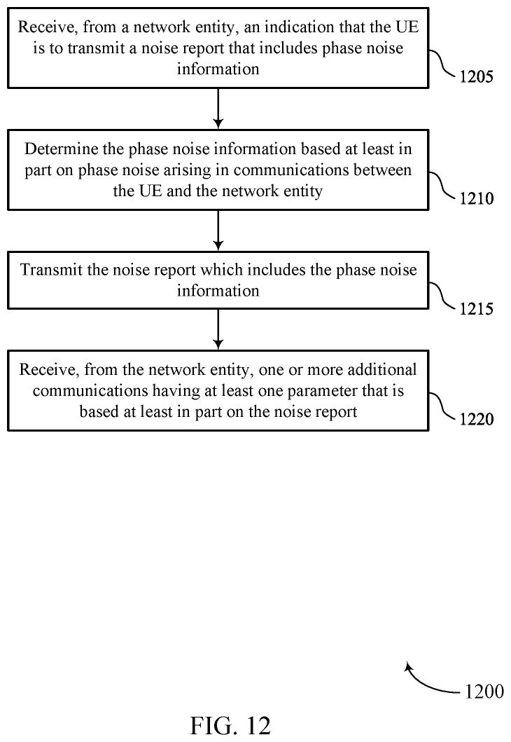

FIG. 12 shows a flowchart illustrating a method 1200 that supports phase noise reporting for constellation and waveform selection in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving, from a network entity, an indication that the UE is to transmit a noise report that includes phase noise information. The operations of 1205 may be performed in accordance with examples as disclosed herein. In some examples, aspects of the operations of 1205 may be performed by a noise report indication component 625 as described with reference to FIG. 6.

At 1210, the method may include determining the phase noise information based on phase noise arising in communications between the UE and the network entity. The operations of 1210 may be performed in accordance with examples as disclosed herein. In some examples, aspects of the operations of 1210 may be performed by a phase noise component 630 as described with reference to FIG. 6.

At 1215, the method may include transmitting the noise report which includes the phase noise information. The operations of 1215 may be performed in accordance with examples as disclosed herein. In some examples, aspects of the operations of 1215 may be performed by a noise report transmission component 635 as described with reference to FIG. 6.

At 1220, the method may include receiving, from the network entity, one or more additional communications having at least one parameter that is based on the noise report. The operations of 1220 may be performed in accordance with examples as disclosed herein. In some examples, aspects of the operations of 1220 may be performed by a phase noise communication component 640 as described with reference to FIG. 6.

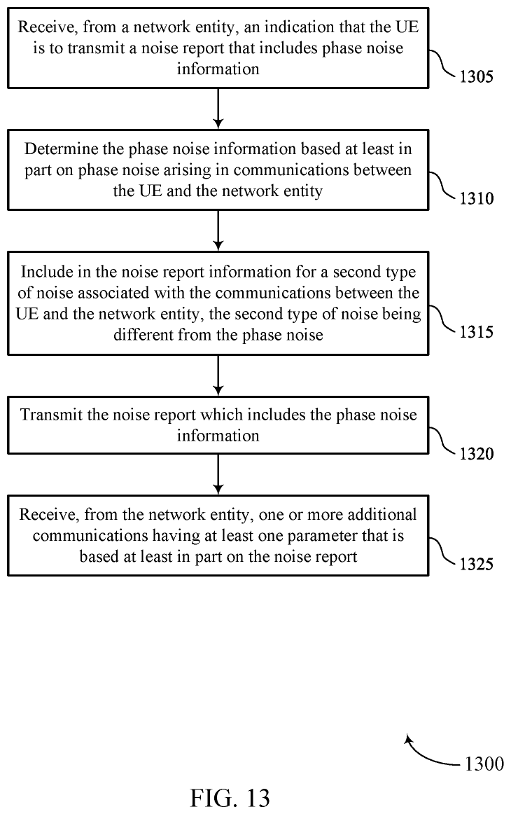

FIG. 13 shows a flowchart illustrating a method 1300 that supports phase noise reporting for constellation and waveform selection in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving, from a network entity, an indication that the UE is to transmit a noise report that includes phase noise information. The operations of 1305 may be performed in accordance with examples as disclosed herein. In some examples, aspects of the operations of 1305 may be performed by a noise report indication component 625 as described with reference to FIG. 6.

At 1310, the method may include determining the phase noise information based on phase noise arising in communications between the UE and the network entity. The operations of 1310 may be performed in accordance with examples as disclosed herein. In some examples, aspects of the operations of 1310 may be performed by a phase noise component 630 as described with reference to FIG. 6.

At 1315, the method may include including in the noise report information for a second type of noise associated with the communications between the UE and the network entity, the second type of noise being different from the phase noise. The operations of 1315 may be performed in accordance with examples as disclosed herein. In some examples, aspects of the operations of 1315 may be performed by a phase noise component 630 as described with reference to FIG. 6.

At 1320, the method may include transmitting the noise report which includes the phase noise information. The operations of 1320 may be performed in accordance with examples as disclosed herein. In some examples, aspects of the operations of 1320 may be performed by a noise report transmission component 635 as described with reference to FIG. 6.

At 1325, the method may include receiving, from the network entity, one or more additional communications having at least one parameter that is based on the noise report. The operations of 1325 may be performed in accordance with examples as disclosed herein. In some examples, aspects of the operations of 1325 may be performed by a phase noise communication component 640 as described with reference to FIG. 6.

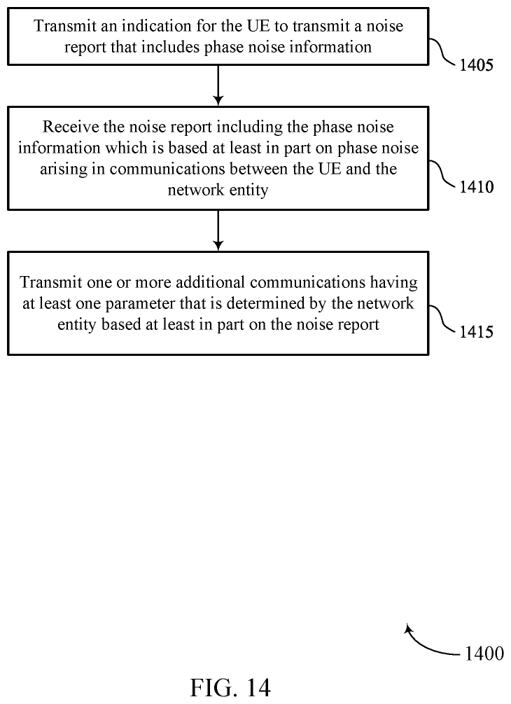

FIG. 14 shows a flowchart illustrating a method 1400 that supports phase noise reporting for constellation and waveform selection in accordance with aspects of the present disclosure. The operations of the method 1400 may be implemented by a network entity or its components as described herein. For example, the operations of the method 1400 may be performed by a network entity 105 as described with reference to FIGS. 1 through 3 and 8 through 11. In some examples, a network entity may execute a set of instructions to control the functional elements of the network entity to perform the described functions. Additionally or alternatively, the network entity may perform aspects of the described functions using special-purpose hardware.

At 1405, the method may include transmitting an indication for the UE to transmit a noise report that includes phase noise information. The operations of 1405 may be performed in accordance with examples as disclosed herein. In some examples, aspects of the operations of 1405 may be performed by a noise report indication manager 1025 as described with reference to FIG. 10.

At 1410, the method may include receiving the noise report including the phase noise information which is based at least in part on phase noise arising in communications between the UE and the network entity. The operations of 1410 may be performed in accordance with examples as disclosed herein. In some examples, aspects of the operations of 1410 may be performed by a noise report component 1030 as described with reference to FIG. 10.

At 1415, the method may include transmitting one or more additional communications having at least one parameter that is determined by the network entity based on the noise report. The operations of 1415 may be performed in accordance with examples as disclosed herein. In some examples, aspects of the operations of 1415 may be performed by a communication parameter component 1035 as described with reference to FIG. 10.

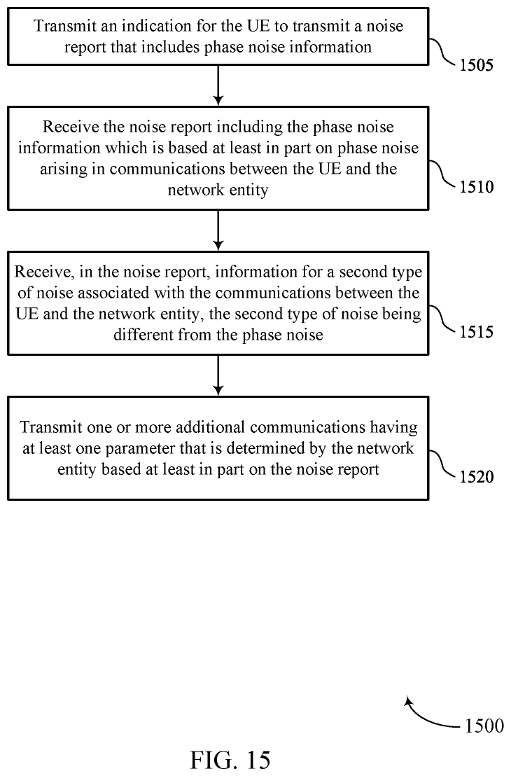

FIG. 15 shows a flowchart illustrating a method 1500 that supports phase noise reporting for constellation and waveform selection in accordance with aspects of the present disclosure. The operations of the method 1500 may be implemented by a network entity or its components as described herein. For example, the operations of the method 1500 may be performed by a network entity 105 as described with reference to FIGS. 1 through 3 and 8 through 11. In some examples, a network entity may execute a set of instructions to control the functional elements of the network entity to perform the described functions. Additionally or alternatively, the network entity may perform aspects of the described functions using special-purpose hardware.

At 1505, the method may include transmitting an indication for the UE to transmit a noise report that includes phase noise information. The operations of 1505 may be performed in accordance with examples as disclosed herein. In some examples, aspects of the operations of 1505 may be performed by a noise report indication manager 1025 as described with reference to FIG. 10.

At 1510, the method may include receiving the noise report including the phase noise information which is based at least in part on phase noise arising in communications between the UE and the network entity. The operations of 1510 may be performed in accordance with examples as disclosed herein. In some examples, aspects of the operations of 1510 may be performed by a noise report component 1030 as described with reference to FIG. 10.

At 1515, the method may include receiving, in the noise report, information for a second type of noise associated with the communications between the UE and the network entity, the second type of noise being different from the phase noise. The operations of 1515 may be performed in accordance with examples as disclosed herein. In some examples, aspects of the operations of 1515 may be performed by a noise report component 1030 as described with reference to FIG. 10.

At 1520, the method may include transmitting one or more additional communications having at least one parameter that is determined by the network entity based on the noise report. The operations of 1520 may be performed in accordance with examples as disclosed herein. In some examples, aspects of the operations of 1520 may be performed by a communication parameter component 1035 as described with reference to FIG. 10.

The following provides an overview of aspects of the present disclosure:

Aspect 1: A method for wireless communication at a UE comprising: receiving, from a network entity, an indication that the UE is to transmit a noise report that includes phase noise information; determining the phase noise information based at least in part on phase noise arising in communications between the UE and the network entity; transmitting the noise report which includes the phase noise information; and receiving, from the network entity one or more additional communications having at least one parameter that is based at least in part on the noise report.

Aspect 2: The method of aspect 1, wherein transmitting the noise report further comprises: including in the noise report, information for a second type of noise associated with the communications between the UE and the network entity, the second type of noise being different from the phase noise.

Aspect 3: The method of aspect 2, wherein determining the phase noise information further comprises: determining a relative level of the phase noise with respect to the second type of noise.

Aspect 4: The method of any of aspects 2 through 3, wherein determining the phase noise information further comprises: determining a level of the phase noise, the level of the phase noise to be included in the noise report in addition to an additional level of the second type of noise.

Aspect 5: The method of any of aspects 2 through 4, wherein the second type of noise comprises thermal noise.

Aspect 6: The method of any of aspects 1 through 5, wherein determining the phase noise information further comprises: determining a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

Aspect 7: The method of any of aspects 1 through 6, wherein receiving the indication comprises: receiving control signaling comprising the indication to transmit the noise report.

Aspect 8: The method of aspect 7, wherein the control signaling comprises a channel state information reference signal.

Aspect 9: The method of any of aspects 1 through 8, further comprising: receiving an additional indication that at least one parameter has changed for one or more additional communications received from the network entity, wherein the at least one parameter is changed based at least in part on the noise report, and wherein the at least one parameter is from a plurality of parameters that pertain to a square QAM, a non-square QAM, differential modulation, non-differential modulation, a single carrier waveform, a multi-carrier waveform, or combinations thereof.

Aspect 10: A method for wireless communication at a network entity, comprising: transmitting an indication for the UE to transmit a noise report that includes phase noise information; receiving the noise report including the phase noise information which is based at least in part on phase noise arising in communications between the UE and the network entity; and transmitting one or more additional communications having at least one parameter that is determined by the network entity based at least in part on the noise report.

Aspect 11: The method of aspect 10, wherein receiving the noise report further comprises: receiving, in the noise report, information for a second type of noise associated with the communications between the UE and the network entity, the second type of noise being different from the phase noise.

Aspect 12: The method of aspect 11, wherein receiving the noise report further comprises: receiving, in the noise report, a relative level of the phase noise with respect to the second type of noise.

Aspect 13: The method of any of aspects 11 through 12, wherein receiving the noise report further comprises: receiving, in the noise report, a level of the phase noise in addition to an additional level of the second type of noise.

Aspect 14: The method of any of aspects 11 through 13, wherein the second type of noise comprises thermal noise.

Aspect 15: The method of any of aspects 10 through 14, wherein receiving the noise report further comprises: receiving, in the noise report, a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

Aspect 16: The method of any of aspects 10 through 15, further comprising: selecting the at least one parameter from a plurality of parameters based at least in part on the phase noise information included in the noise report.

Aspect 17: The method of aspect 16, wherein the plurality of parameters comprises one or more of a square QAM, a non-square QAM, differential modulation, non-differential modulation, a single carrier waveform, or a multi-carrier waveform.

Aspect 18: The method of any of aspects 10 through 17, wherein transmitting the indication comprises: transmitting control signaling comprising the indication for the UE to transmit the noise report.

Aspect 19: The method of aspect 18, wherein the control signaling comprises a channel state information reference signal.

Aspect 20: An apparatus comprising a memory; and a processor coupled with the memory, wherein the memory comprises instructions executable by the processor to cause the apparatus to perform a method of any of aspects 1 through 9.

Aspect 21: An apparatus comprising at least one means for performing a method of any of aspects 1 through 9.

Aspect 22: A non-transitory computer-readable medium storing code the code comprising instructions executable by a processor to perform a method of any of aspects 1 through 9.

Aspect 23: An apparatus for wireless communication at a network entity, comprising a memory; and a processor coupled with the memory, wherein the memory comprises instructions executable by the processor to cause the apparatus to perform a method of any of aspects 10 through 19.

Aspect 24: An apparatus for wireless communication at a network entity, comprising at least one means for performing a method of any of aspects 10 through 19.

Aspect 25: A non-transitory computer-readable medium storing code for wireless communication at a network entity, the code comprising instructions executable by a processor to perform a method of any of aspects 10 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database, or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE) comprising:
receiving, from a network entity, an indication that the UE is to transmit a noise report that includes phase noise information;
determining the phase noise information based at least in part on phase noise arising in communications between the UE and the network entity;
transmitting the noise report which includes the phase noise information; and
receiving, from the network entity, one or more additional communications having at least one parameter that is based at least in part on the noise report.

2. The method of claim 1, wherein transmitting the noise report further comprises:
including in the noise report, information for a second type of noise associated with the communications between the UE and the network entity, the second type of noise being different from the phase noise.

3. The method of claim 2, wherein determining the phase noise information further comprises:
determining a relative level of the phase noise with respect to the second type of noise.

4. The method of claim 2, wherein determining the phase noise information further comprises:
determining a level of the phase noise, the level of the phase noise to be included in the noise report in addition to an additional level of the second type of noise.

5. The method of claim 2, wherein the second type of noise comprises thermal noise.

6. The method of claim 1, wherein determining the phase noise information further comprises:
determining a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

7. The method of claim 1, wherein receiving the indication comprises:
receiving control signaling comprising the indication to transmit the noise report.

8. The method of claim 7, wherein the control signaling comprises a channel state information reference signal.

9. The method of claim 1, further comprising:
receiving an additional indication that at least one parameter has changed for one or more additional communications received from the network entity, wherein the at least one parameter is changed based at least in part on the noise report, and wherein the at least one parameter is from a plurality of parameters that pertain to a square quadrature amplitude modulation, a non-square quadrature amplitude modulation, differential modulation, non-differential modulation, a single carrier waveform, a multi-carrier waveform, or combinations thereof.

10. A method for wireless communication at a network entity, comprising:
transmitting an indication for a user equipment (UE) to transmit a noise report that includes phase noise information;
receiving the noise report including the phase noise information which is based at least in part on phase noise arising in communications between the UE and the network entity; and
transmitting one or more additional communications having at least one parameter that is determined by the network entity based at least in part on the noise report.

11. The method of claim 10, wherein receiving the noise report further comprises:
receiving, in the noise report, information for a second type of noise associated with the communications between the UE and the network entity, the second type of noise being different from the phase noise.

12. The method of claim 11, wherein receiving the noise report further comprises:
receiving, in the noise report, a relative level of the phase noise with respect to the second type of noise.

13. The method of claim 11, wherein receiving the noise report further comprises:
receiving, in the noise report, a level of the phase noise in addition to an additional level of the second type of noise.

14. The method of claim 11, wherein the second type of noise comprises thermal noise.

15. The method of claim 10, wherein receiving the noise report further comprises:
receiving, in the noise report, a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

16. The method of claim 10, further comprising:
selecting the at least one parameter from a plurality of parameters based at least in part on the phase noise information included in the noise report.

17. The method of claim 16, wherein the plurality of parameters comprises one or more of a square quadrature amplitude modulation, a non-square quadrature amplitude modulation, differential modulation, non-differential modulation, a single carrier waveform, or a multi-carrier waveform.

18. The method of claim 10, wherein transmitting the indication comprises:
transmitting control signaling comprising the indication for the UE to transmit the noise report.

19. The method of claim 18, wherein the control signaling comprises a channel state information reference signal.

20. An apparatus at a user equipment (UE), comprising:
a memory; and
a processor coupled with the memory, wherein the memory comprises instructions executable by the processor to cause the apparatus to:
receive, from a network entity, an indication that the UE is to transmit a noise report that includes phase noise information;
determine the phase noise information based at least in part on phase noise arising in communications between the UE and the network entity;
transmit the noise report which includes the phase noise information; and
receive, from the network entity, one or more additional communications having at least one parameter that is based at least in part on the noise report.

21. The apparatus of claim 20, wherein the instructions to transmit the noise report are further executable by the processor to cause the apparatus to:
include in the noise report, information for a second type of noise associated with the communications between the UE and the network entity, the second type of noise being different from the phase noise.

22. The apparatus of claim 21, wherein the instructions to determine the phase noise information are further executable by the processor to cause the apparatus to:
determine a relative level of the phase noise with respect to the second type of noise.

23. The apparatus of claim 21, wherein the instructions to determine the phase noise information are further executable by the processor to cause the apparatus to:
determine a level of the phase noise, the level of the phase noise to be included in the noise report in addition to an additional level of the second type of noise.

24. The apparatus of claim 21, wherein the second type of noise comprises thermal noise.

25. The apparatus of claim 20, wherein the instructions to determine the phase noise information are further executable by the processor to cause the apparatus to:
determine a phase noise level associated with a frequency of the communications between the UE and the network entity, a cutoff frequency associated with a set of frequencies for the communications between the UE and the network entity, a rate of change of the phase noise as a function of frequency for the communications between the UE and the network entity, a type of rate of change of the phase noise as a function of frequency for the communications between the UE and the network entity, or a combination thereof.

26. The apparatus of claim 20, wherein the instructions to receive the indication are executable by the processor to cause the apparatus to:
receive control signaling comprising the indication to transmit the noise report.

27. The apparatus of claim 26, wherein the control signaling comprises a channel state information reference signal.

28. The apparatus of claim 20, wherein the instructions are further executable by the processor to cause the apparatus to:
receive an additional indication that at least one parameter has changed for one or more additional communications received from the network entity, wherein the at least one parameter is changed based at least in part on the noise report, and wherein the at least one parameter is from a plurality of parameters that pertain to a square quadrature amplitude modulation, a non-square quadrature amplitude modulation, differential modulation, non-differential modulation, a single carrier waveform, a multi-carrier waveform, or combinations thereof.

29. An apparatus for wireless communication at a network entity, comprising:
a memory; and
a processor coupled with the memory, wherein the memory comprises instructions executable by the processor to cause the apparatus to:
transmit an indication for a user equipment (UE) to transmit a noise report that includes phase noise information;
receive the noise report including the phase noise information which is based at least in part on phase noise arising in communications between the UE and the network entity; and
transmit one or more additional communications having at least one parameter that is determined by the network entity based at least in part on the noise report.

30. The apparatus of claim 29, wherein the instructions to receive the noise report are further executable by the processor to cause the apparatus to:
receive, in the noise report, information for a second type of noise associated with the communications between the UE and the network entity, the second type of noise being different from the phase noise.
